(19) United States
(12) Patent Application Publication
(10) Pub. No.: US 2014/0079239 A1
(43) Pub. Date: Mar. 20, 2014

(54) SYSTEM AND APPARATUS FOR CONTROLLING A USER INTERFACE WITH A BONE CONDUCTION TRANSDUCER

(71) Applicants: Uri Yehuday, Bat Yam (IL); Arie Heiman, Sde Warburg (IL)

(72) Inventors: Uri Yehuday, Bat Yam (IL); Arie Heiman, Sde Warburg (IL)

(73) Assignee: Bonetone Communications Ltd., Tortola (VG)

(21) Appl. No.: 14/007,767

(22) PCT Filed: Mar. 29, 2012
(86) PCT No.: PCT/IB12/51524

§ 371 Date: Nov. 20, 2013

Related U.S. Application Data
(60) Provisional application No. 61/470,498, filed on Apr. 1, 2011.

(51) Int. Cl. H04R 1/46

(52) U.S. Cl. CPC H04R 1/46
USPC 381/74

(57) ABSTRACT

An input device to a headpiece includes a bone conduction microphone and an instruction generator. The bone conduction microphone detects vibrations. The instruction generator detects a pattern in the vibrations caused by a user's patterned contact with either the headpiece or the user's head and translates the pattern into a set of instructions to the headpiece according to a pre-determined look up table.

### CROSS-REFERENCE TO RELATED APPLICATIONS

This application claims benefit from U.S. Provisional Patent Application 61/470,498, filed 1 Apr. 2011, which is hereby incorporated in its entirety by reference.

### FIELD OF THE INVENTION

The present invention relates to bone conduction microphones generally and to headsets and earpieces in particular.

### BACKGROUND OF THE INVENTION

The use of mobile communication and entertainment devices, such as mobile phones, tablets and portable music devices has become very popular. To listen to the content, some users prefer to use a wire or wireless headset or earpiece, such as a Bluetooth mono or stereo headset. These headsets typically include control keys for functionality, such as answering/ending a call, adjusting volume level and muting/ un-muting etc. To meet these different functionalities and others, such as balancing the speakers, moving through songs etc., different buttons are required. Due to the limitations of size of the device in use, the buttons provided are often very small and often have multiple functionalities as defined by the time duration or the sequence that the user presses.

Since all this selection and adjusting is often done ‘blindly’ with the headset already in place, often the wrong button is activated. This may especially be problematic with buttons that are invisible to the user, such as those in a Bluetooth earpiece.

### SUMMARY OF THE PRESENT INVENTION

There is provided, in accordance with a preferred embodiment of the present invention, an input device to a headpiece. The input device includes a bone conduction microphone and an instruction generator. The microphone detects vibrations and the instruction generator detects a pattern in the vibrations caused by a user's patterned contact with either the headpiece or the user's head. The instruction generator also translates the pattern into a set of instructions to the headpiece according to a pre-determined look up table.

Moreover, in accordance with a preferred embodiment of the present invention, the instruction generator includes an analyzer to analyze the vibrations for predefined patterns.

Further, in accordance with a preferred embodiment of the present invention, the predefined patterns are a tapping of the headpiece or the head.

Still further, in accordance with a preferred embodiment of the present invention, the tapping includes a short tap, a sustained tap or a combination thereof.

Additionally, in accordance with a preferred embodiment of the present invention, the predefined patterns are a sliding over a portion of the head or headpiece over a predetermined length of time.

There is provided, in accordance with a preferred embodiment of the present invention, a headpiece. The headpiece includes an operating system for the headpiece, a bone conduction microphone for detecting vibrations and an instruction generator. The instruction generator detects a pattern in the vibrations caused by a user's patterned contact with either the earpiece or the user's head and translates the pattern into a set of instructions to the operating system according to a pre-determined look up table.

Moreover, in accordance with a preferred embodiment of the present invention, the instruction generator includes an analyzer to analyze the vibrations for predefined patterns.

Further, in accordance with a preferred embodiment of the present invention, the predefined patterns are a tapping of the headpiece or head.

Still further, in accordance with a preferred embodiment of the present invention, the tapping includes a short tap, a sustained tap or a combination thereof.

Moreover, in accordance with a preferred embodiment of the present invention, the predefined patterns are a sliding on a portion of said head or headpiece over a predetermined length of time.

There is provided, in accordance with a preferred embodiment of the present invention, a method implementable on a computing device of controlling a headpiece. The method includes detecting vibrations, with a bone conduction microphone, caused by a user's patterned contact with either the headpiece or the user's head. The method also processes predefined patterns of the vibrations using a predefined lookup table of instructions, determines an associated instruction and provides the determined instruction to the headpiece.

Additionally, in accordance with a preferred embodiment of the present invention, the predefined patterns are a tapping of the headpiece or head.

Further in accordance with a preferred embodiment of the present invention, the tapping includes a short tap, a sustained tap or a combination thereof.

Finally, in accordance with a preferred embodiment of the present invention, the vibrations are a result of sliding over a portion of the head or headpiece over a predetermined length of time.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of system providing input to an earpiece constructed and operative in accordance with the present invention,

FIG. 2 is a block diagram illustration of the elements forming the system of FIG. 1, constructed and operative in accordance with the present invention,

FIG. 3 is an exemplary signal of three knocks that may be recognized by bone conduction microphone constructed and operative in accordance with the present invention,

FIG. 4 is an exemplary lookup table constructed and operative in accordance with the present invention, and

FIG. 5 is a schematic illustration of an alternative embodiment of FIG. 1 constructed and operative in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Bone conduction is the conduction of sound to the inner ear through the bones of the skull. Bone conduction transducers or microphones are known in the art as devices for converting the vibration signal that is picked up from the bone into an analog or digital voice signal. The resultant signal may be further processed and used accordingly. It will be appreciated that a bone conduction microphone can be embedded in any device that directly touches the skull or the head.

Applicants have realized that this technology may be useful for controlling headsets and earpieces, such as those described hereinabove, when suitably embedded. Applicants have further realized that this technology may also be adapted for any form of headgear that sits in direct contact with the head and where a bone conduction microphone may be embedded.

It will be appreciated that any digitally controlled headpiece or earpiece may be used. The present discussion presents examples using a Bluetooth earpiece.

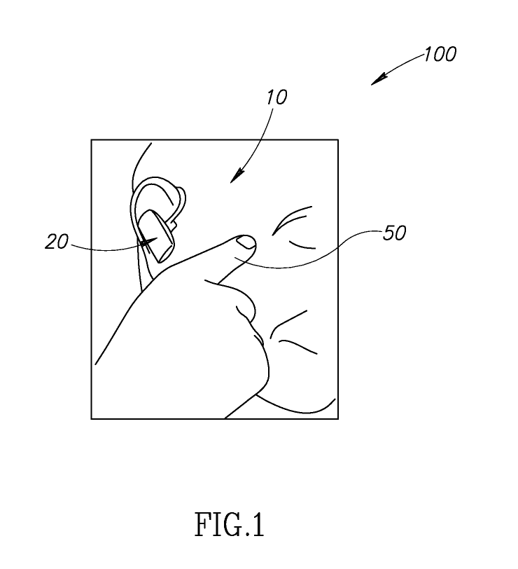

Reference is now made to FIG. 1 which illustrates a system 100 for providing input to an earpiece, such as a typical Bluetooth earpiece 20. When user 10 taps the side of his head using his finger 50, he may set off a pattern of pulses which may vibrate throughout his skull.

It will be appreciated that user 10 may knock or scratch his head at any location.

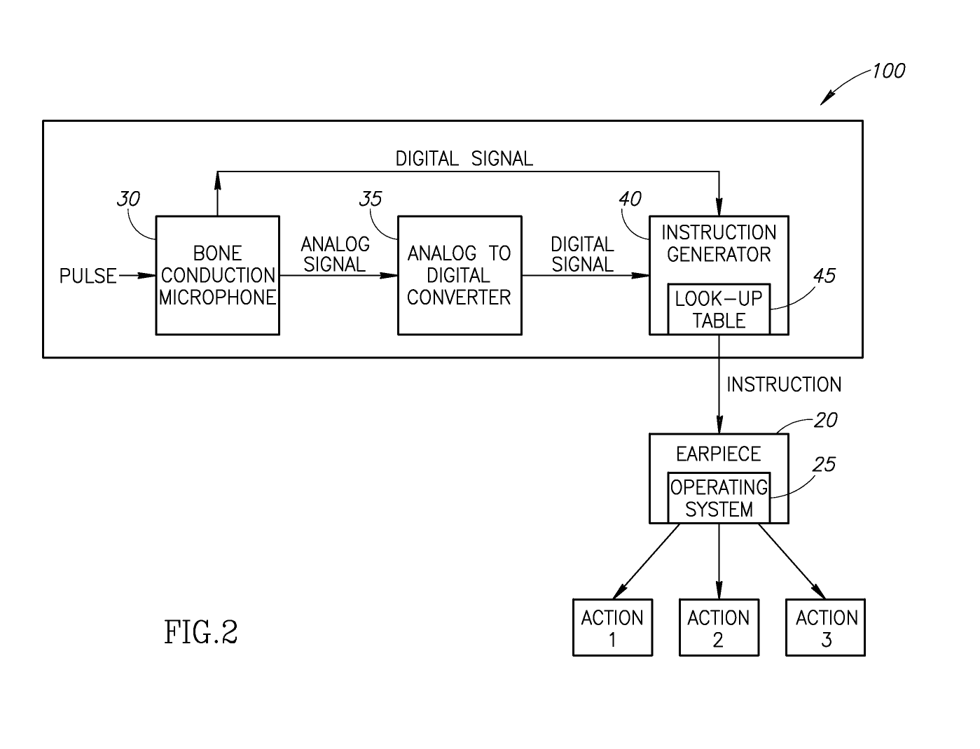

Reference is now made to FIG. 2 which shows a block diagram of the elements of system 100, constructed and operative in accordance with a preferred embodiment of the present invention. System 100 may comprise bone conduction microphone 30, an analog to digital convertor 35 and an instruction generator 40 and may provide instructions to an operating system 25 of earpiece 20. System 100 may provide instructions from a user to a headpiece or an earpiece, such as earpiece 20.

Bone conduction microphone 30, which may be embedded within earpiece 20 and may touch the head (and therefore the skull) of user 10, may pick up the pulses of the vibration that pass through the skull when user 10 taps his head and may convert them into an analog signal and/or a digital signal. If required, the analog signal may then be digitized by analog to digital convertor 35 with appropriate amplification. The digital signal produced may be further received and analyzed by instruction generator 40 which may use a lookup table 45 to interpret the desired action according to the pattern of the pulses in the received signal. Instruction generator 40 may then instruct operating system 25 which in turn may instruct earpiece 20 to function according to the required action, such as answering a phone call or playing music.

It will be appreciated that instruction generator 40 may also be embedded as part of operating system 25.

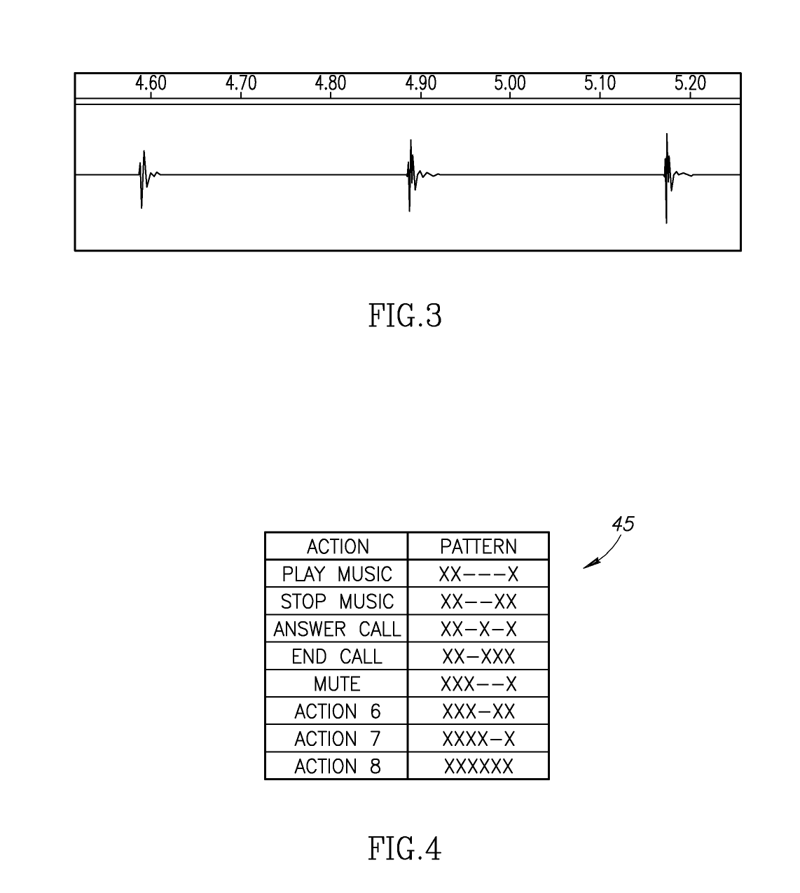

Reference is now made to FIG. 3 which illustrates an exemplary signal of three knocks that may be recognized by bone conduction microphone 30. In FIG. 3, the knocks are approximately 0.3 seconds apart though this is exemplary. System 100 may recognize these knocks and may compare the pattern of knocks with preset patterns assigned to instructions for earpiece 20.

Reference is now made to FIG. 4 which illustrates an example of lookup table 45. As mentioned above, the different functionalities of earpiece 20 may be associated with predefined patterns of pulses. In the table “x” represents a single tap and “-”represents a pause. For example, user 10 may tap his head twice quickly, pause and then tap once again. The pattern “xx---x” may be assigned to the action “play music”.

It will be appreciated that user 10 may touch or knock his head, or even his teeth, unintentionally, and instruction generator 40 may still interpret the knocking as a valid command, which may generate a false action. To reduce the false action probability, the defined patterns need to be unique, i.e. patterns that are not likely to be done by user 10 subconsciously or as part of his daily routine. A solution may be to start each pattern with two taps. It will be further appreciated that if instruction generator 40 does not find a pattern match within a predetermined length of time, it will return a false negative and no function is activated.

In an alternative embodiment of the present invention, user 10 may use a drawn out contact with his head, such as a scratch, for further functionality. The pattern of vibrations created may also be detected by bone conduction microphone 30 and may be analyzed by instruction generator 40 to identify the desired functionality as described hereinabove. It will be appreciated that the signal generated by a scratch may differ from those generated by a tap and may last for a longer length of time. Lookup table 45 may be adjusted accordingly to interpret these signals. It will be further appreciated that the sliding action of a scratch may also be interpreted as a volume slider. If the movement of an upward scratch is distinguishable from the movement of a downward scratch, the resulting actions may be used to increase and decrease volume. Volume may be increased or decreased linearly in correlation with the length of time finger 50 is in contact with the head.

It will be further appreciated that user 10 may also tap earpiece 20 instead of his head to instruct it. The resultant vibrations may also be detected by bone conduction microphone 30 (typically housed in the earpiece being tapped) and analyzed by instruction generator 40 to identify the desired command as described hereinabove.

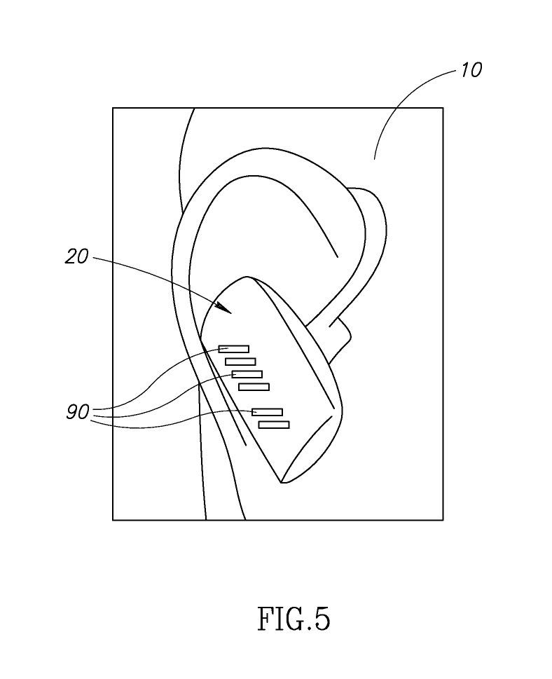

Reference is now made to FIG. 5 which illustrates the front panel of a Bluetooth earpiece 20 comprising a selection of pits 90. In an alternative embodiment of the present invention, instead of scratching his head, user 10 may slide his finger 50 over pits 90. The jerky movement of finger 50 over pits 90 may also generate a pattern of vibrations similar to the tapping described hereinabove. The resultant vibrations may also be detected by bone conduction microphone 30 and processed as described hereinabove. It will be appreciated that running finger 50 over pits 90 may also be interpreted by lookup table 45 in the same manner as a scratch in order to increase and decrease volume.

It will be further appreciated that this method of controlling earpiece 20 by “tapping” and “scratching” the head may override the necessity to use the buttons and switches of an earpiece.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An input device to a headpiece, the input device comprising:
a bone conduction microphone for detecting vibrations; and
an instruction generator to detect a pattern in said vibrations caused by a user's patterned contact with either said headpiece or said user's head and to translate said pattern into a set of instructions to said headpiece according to a pre-determined look up table.

2. The input device according to claim 1 and wherein said instruction generator comprises an analyzer to analyze said vibrations for predefined patterns.

3. The input device according to claim 2 and wherein said predefined patterns are a tapping of said headpiece or head.

4. The input device according to claim 3 where said tapping comprises at least one of the following: a short tap, a sustained tap, and a combination thereof.

5. The input device according to claim 2 wherein said predefined patterns are a sliding over a portion of said head or headpiece over a predetermined length of time.

6. A headpiece comprising:
an operating system for said headpiece;
a bone conduction microphone for detecting vibrations; and
an instruction generator to detect a pattern in said vibrations caused by a user's patterned contact with either said headpiece or said user's head and to translate said pattern into a set of instructions to said operating system according to a pre-determined look up table.

7. The input device according to claim 6 and wherein said instruction generator comprises an analyzer to analyze said vibrations for predefined patterns.

8. The input device according to claim 7 and wherein said predefined patterns are a tapping of said headpiece or head.

9. The input device according to claim 8 where said tapping comprises at least one of the following: a short tap, a sustained tap, and a combination thereof.

10. The input device according to claim 7 wherein said predefined patterns are a sliding over a portion of said head or headpiece over a predetermined length of time.

11. A method implementable on a computing device of controlling a headpiece, said method comprising:
detecting with a bone conduction microphone, vibrations caused by a user's patterned contact with either said headpiece or said user's head;
processing predefined patterns of said vibrations using a predefined lookup table of instructions and determining an associated instruction; and
providing the determined instruction to said headpiece.

12. The method according to claim 11 and wherein said predefined patterns are a tapping of said headpiece or head.

13. The method according to claim 12 and wherein said tapping comprises at least one of the following: a short tap, a sustained tap, and a combination thereof.

14. The method according to claim 11 wherein said vibrations are a result of sliding over a portion of said head or headpiece over a predetermined length of time.
